(19) United States
(12) Patent Application Publication
(10) Pub. No.: US 2015/0134801 A1
(43) Pub. Date: May 14, 2015

(54) MAKING POLICY-BASED DECISIONS IN A NETWORK

(71) Applicant: BROADCOM CORPORATION, Irvine, CA (US)

(72) Inventors: John Stuart WALLEY, Ladera Ranch, CA (US); Nicholas ILYADIS, Merrimack, NH (US); Stephen Wilson BAILEY, Hong Kong (HK); Wael William DIAB, San Francisco, CA (US)

(73) Assignee: BROADCOM CORPORATION, Irvine, CA (US)

(21) Appl. No.: 14/166,683

(22) Filed: Jan. 28, 2014

Related U.S. Application Data
(60) Provisional application No. 61/922,040, filed on Dec. 30, 2013.
(60) Provisional application No. 61/904,432, filed on Nov. 14, 2013.

(51) Int. Cl. H04L 12/24

(52) U.S. Cl. CPC H04L 41/00
USPC 709/223

(57) ABSTRACT

A method is provided for making policy-based decisions in a network. The method can include receiving data values from a sensor at multiple time instances. The method can also include selecting a policy associated with the received data values, where the policy includes a condition and an action. The method can also include determining whether a data value among the received data values satisfies the condition at one or more time instances. The method can also include performing the action of the policy if the condition of the policy is satisfied at one or more time instances. The method can also include determining a pattern from the received data values based on changes in the received data values as a function of time. The method can also include preparing adjustments to the policy based on the determined pattern.

### CROSS-REFERENCE TO RELATED APPLICATIONS

The present application claims the benefit of U.S. Provisional Patent Application No. 61/922,040, entitled “Making Policy-based Decisions in a Network”, filed on Dec. 30, 2013, and U.S. Provisional Patent Application No. 61/904,432, entitled “Interoperable Devices”, filed on Nov. 14, 2013, each of which is hereby incorporated by reference in its entirety for all purposes.

### TECHNICAL FIELD

The present description relates generally to a network, and more particularly, but not exclusively, to making policy-based decisions in a network.

### BACKGROUND

A network can include the Internet, a private network, an Internet of Things (IoT) network, or other networks. The IoT network refers to a network structure that can link one or more devices. The devices can be designed to receive, sense, and/or transmit information as well as communicate with one another. Each device in an IoT network can be identified by an identifier such as a radio-frequency identification (RFID), an address (e.g., Internet address), or other identification means within the IoT or the Internet. An IoT network can include devices such as sensors that sense information relevant to a user and/or a user's surroundings. Examples of sensors include video cameras, audio recorders, barometers, thermometers, smoke detectors, and so forth. An IoT network can also include devices such as actuators that can access data provided by the sensors and, based on information available from the sensors, make decisions on behalf of the user.

### SUMMARY

Devices and methods are provided for making policy-based decisions in a network, substantially as illustrated by and/or described in connection with at least one of the figures, as set forth more completely in the claims.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example of a network environment for implementing a system of interoperable devices in accordance with one or more implementations of the subject technology.

FIGS. 2A and 2B illustrate example networks of interoperable devices in accordance with one or more implementations.

FIG. 3 shows a flowchart illustrating an example process for making policy-based decisions in a network, in accordance with various implementations.

FIG. 4 illustrates another example network of interoperable devices in accordance with one or more implementations.

FIG. 5 conceptually illustrates an example electronic system with which some implementations of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and can be practiced using one or more implementations. In one or more instances, well-known structures and components are shown in block diagram form in order to avoid obscuring the concepts of the subject technology.

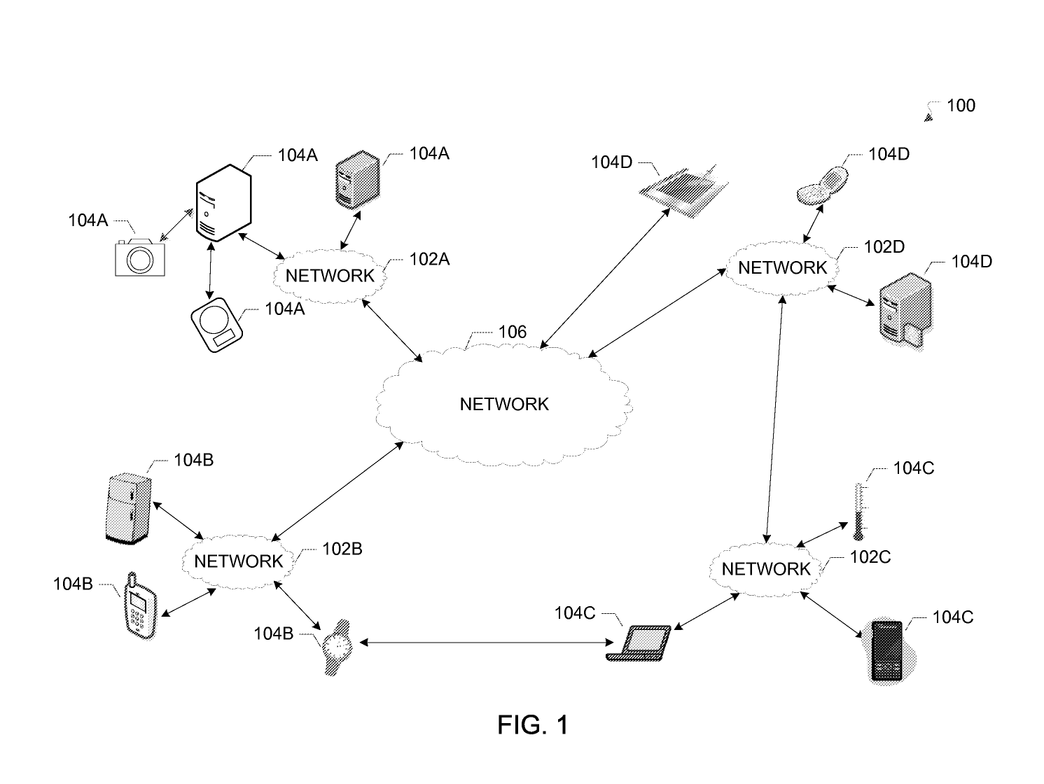

FIG. 1 illustrates an example of a network environment 100 for implementing a system of interoperable devices in accordance with one or more implementations of the subject technology. Not all of the depicted components may be required, however, and one or more implementations may include additional components not shown in the figure. Variations in the arrangement and type of the components can be made without departing from the spirit or scope of the claims as set forth herein. Additionally, different components, fewer components, or more components can be provided.

The network environment 100 includes the Internet, a private network, an IoT network, or other networks. The example network environment 100 includes a number of electronic devices 104A, 104B, 104C, 104D (hereafter referred to as 104A-104D) and a number of networks 102A, 102B, 102C, 102D (hereafter referred to as 102A-102D), and 106. One or more of the devices 104A-104D, such as the device 104A, can be any device capable of communicating with one or more other devices of the devices 104A-104D, e.g. via wired or wireless communication. In some aspects, the devices 104A-104D can include, be embedded in, or be coupled to a portable device such as a portable communication device including a mobile phone, a laptop, a tablet, or any other communication device. The devices 104A-104D can be communicably coupled to one or more of the networks 102A-102D, 106 and/or to one or more other devices of the devices 104A-104D. As shown in FIG. 1, examples of any one of devices 104A-104D can include, or can be, a general desktop computer, a laptop, a tablet, a scale, a thermometer, a cell phone (e.g., smartphone), a refrigerator, a watch, and so forth. Other devices not shown in FIG. 1 can also be employed, such as blood pressure meters, ohmmeters, multimeters, barometers, and so forth.

One or more of the networks 102A-102D and 106 include one or more wired or wireless network devices that facilitate device communication, such as router devices, switch devices, relay devices, etc., and/or include one or more servers. In one or more implementations, one or more of the networks 102A-102D and 106, such as the network 106, can be, or can include, a cloud of computers. In one or more implementations, one or more of the networks 102A-102D can be local area networks that communicatively couple one or more of the devices 104A-104D. One or more of the networks 102A-102D and 106 can be, and/or can include, one or more of a bus network, a star network, a ring network, a relay network, a mesh network, a star-bus network, a tree or hierarchical network, and the like. In one or more implementations, one or more of the networks 102A-102D, 106 can be referred to as an IoT network and/or a machine-to-machine (M2M) network. In one or more implementations, one or more of the devices 104A-104D can be referred to as an IoT device and/or an M2M device. In one or more implementations, there can be multiple paths between one or more of the devices 104A-104D and/or one or more of the networks 102A-102D.

One or more of the networks 102A-102D and/or the devices 104A-104D are able to autonomously communicate with one another (or other systems), e.g. M2M technologies. Thus, one or more of the devices 104A-104D, such as action devices or actuators, can have access to data, e.g. via sensors, that can provide the devices 104A-104D with information relevant to a user and/or the user's surroundings. Accordingly, the devices 104A-104D can utilize available information to make decisions on behalf of the user. One or more of the devices 104A-104D can be configured to make decisions on the users' behalf based on one or more policies. The policies can be user generated or created through heuristics, e.g. a user never answers their phone from person X, a user always keeps their refrigerator stocked with eggs, etc.

An appropriate infrastructure might be required for an IoT network, such as one or more of the networks 102A-102D and 106 to ensure that the necessary processing and sensing resources made available to the appropriate devices 104A-104D without overwhelming the IoT network. Sensors and/or devices 104A-104D can provide data to one or more local or disparate systems and/or devices for open or closed loop decision making processes. The processing and/or decision making can be performed at multiple different levels of one or more of the networks 102A-102D and 106, e.g. larger loops, with the processing and/or decision-making generally occurring as close to the sensor and/or device 104A-104D as possible. In addition, a congestion notification mechanism can allow the edge of the IoT network, such as one or more of the networks 104A-104D to signal that a wave of events is propagating through the network and that some load balancing should occur.

Location information of a device 104A-104D can be obtained from a global positioning system (GPS) or determined based on WiFi signals or by using other methods and/or devices, systems, or signals. The location information of the device 104A-104D can be used in reconfiguration and/or recalibration of the device. The location information of the device can also be used when reporting data provided by the device, for example, the climate data (e.g., temperature, humidity, pressure, etc.), the traffic data (e.g., speed, image, distance from neighboring cars, etc.), or security data (e.g., motion, picture, smoke, etc.).

In one or more implementations, the IoT networks discussed herein can refer to one or more of the networks 102A-102D and 106 and/or a portion of one or more of the networks 102A-102D and 106. In one or more implementations, the sensors and/or devices discussed herein can refer to one or more of the devices 104A-104D, or a portion of one or more of the devices 104A-104D.

In one or more implementations, one or more of the devices 104A-104D in the network can include, or can be, a sensor that can measure a physical quantity and convert the physical quantity into a signal. Examples of sensors include, by way of example and not of limitation, temperature sensors, video cameras, audio recorders, motion sensors, humidity sensors, smoke detectors, various gas sensors, radiation monitors, and other sensors. In some aspects, a sensor can be a smart sensor that includes, but is not limited to, processing logic such as one or more controllers or processors, memory, and communication interfaces.

In one or more implementations, one or more of the devices 104A-104D can include, or can be, an active device or actuator that can receive data from, retrieve data from, or otherwise have access to data stored in or provided by one or more sensors and, based on information available from the sensors, can make decisions on behalf of a user. In some aspects, an active device or actuator can include, but is not limited to, processing logic such as one or more controllers or processors, memory, and communication interfaces.

One or more sensors in a network can sense data and transmit the data to one or more active devices or actuators at certain moments in time, referred to as time instances. Based on type of information received from the sensors (e.g., temperature, pressure, etc.), an active device or actuator can select a policy that is associated with the received data values. For example, if pressure information is received by an actuator, the actuator can select a policy that is associated with pressure values. In one or more implementations, a sensor and an active device or actuator can be within a single device. In some aspects, the sensors, active devices, and actuators can also be embedded in or coupled to a communication device, including a computer, mobile phone, laptop, or other device capable of communication.

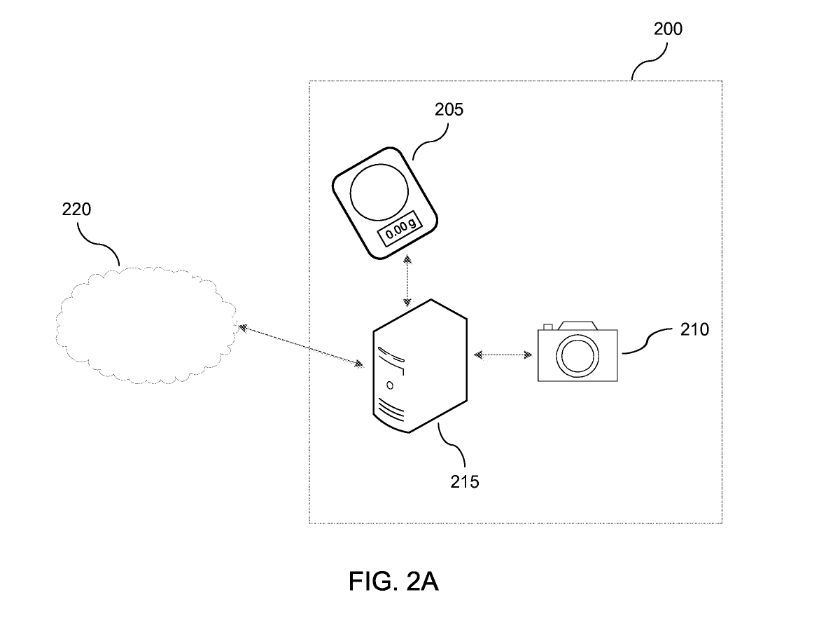

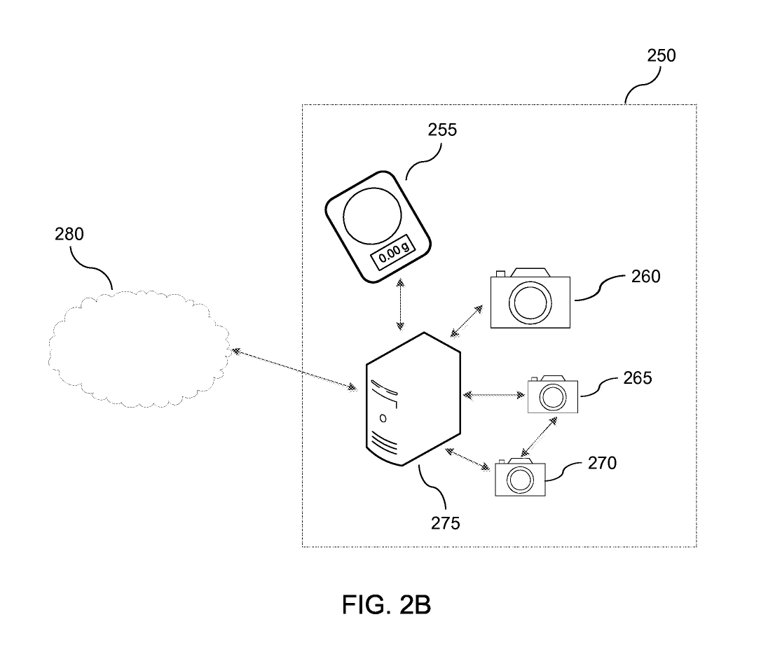

FIG. 2A illustrates an example network 200 of interoperable devices in accordance with one or more implementations. The network 200 includes a weight measuring device 205, a camera 210, and a computer 215. The network 200 can be connected to another network 220, such as the Internet. As shown in FIG. 2A, the network 200 can be connected to the network 220 via the computer 215.

For discussion purposes, the network 200 can include a sensor that counts the number of eggs, referred to herein as an egg count, in a refrigerator and an actuator that receives the egg count from the sensor. The sensor can be, by way of example, a weight measuring device 205 that can weigh the eggs and estimate the number of eggs based on the weight, a camera 210 that can count the number of eggs, a combination thereof, and so forth. The weight measuring device 205 can be a scale in a tray that holds the eggs, weighs the tray, and determines (e.g., estimates) the number of eggs based on the weight for example. The camera 210 can record a video or take snapshots of the contents inside the refrigerator for example. The camera 210 can process the video or snapshots itself to count the number of eggs in the refrigerator (e.g., object recognition processes to determine the number of eggs), or the camera 210 can send the video or snapshots to another processor (e.g., computer 215 or some other device not shown in FIG. 2A) to determine the number of eggs. Alternatively or in conjunction, the camera 210 can record a video or take snapshots of a user removing eggs from the refrigerator. The weight measuring device 205 and the camera 210 are provided by way of example, and other devices and manners by which to estimate the number of eggs can be utilized.

The actuator can be a processor external to the refrigerator, such as a processor in the computer 215, that receives and processes the sensed information. Alternatively or in conjunction, the actuator can be a processor that is part of the refrigerator (e.g., a processor within the refrigerator). The actuator can receive and process the sensed information from one or both of the weight measuring device 205 and the camera 210. For example, in cases where the number of eggs needs to be known precisely, the sensed information from both the weight measuring device 205 and the camera 210 can be received and processed by the computer 215. Alternatively, in cases where a rough estimate of the number of eggs is sufficient, the computer 215 might decide to receive and process information from only one of the weight measuring device 205 or the camera 210. In such cases, the computer 215 can explicitly instruct one of the weight measuring device 205 or the camera 210 to not sense for and not transmit the egg count (e.g., for power consideration).

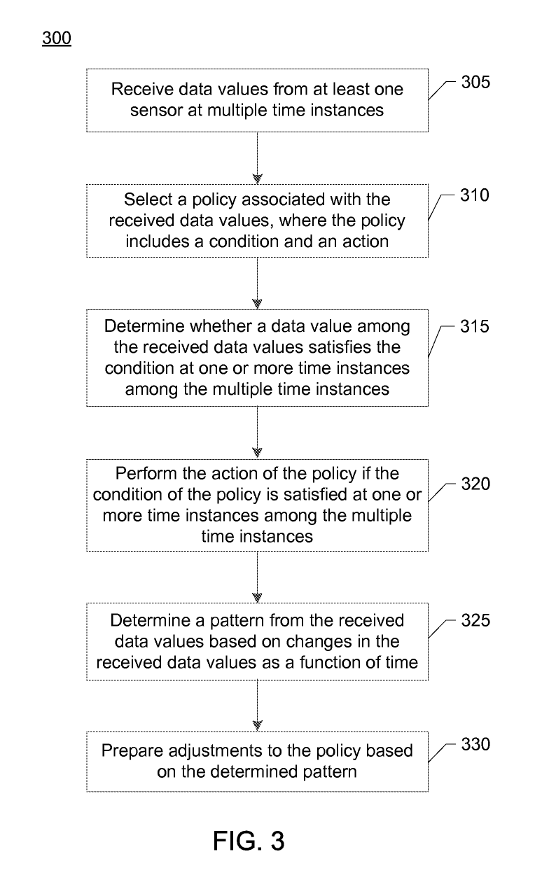

In accordance with one or more implementations, methods and systems for making policy-based decisions in a network, such as the network 200 shown in FIG. 2A, are provided. A policy includes a condition and an action to be performed when the condition is satisfied. FIG. 2A will be discussed with reference to FIG. 3. FIG. 3 shows a flowchart illustrating an example process 300 for making policy-based decisions in a network, in accordance with various implementations of the present disclosure. The steps of the process 300 do not need to be performed in the order shown. It is understood that the depicted order is an illustration of one or more example approaches, and are not meant to be limited to the specific order or hierarchy presented. The steps may be rearranged, and/or two or more of the steps may be performed simultaneously.

Data values can be received at multiple time instances (305). With reference to the example above, the data values (e.g., egg counts) can be received by the computer 215 from at least one of the weight measuring device 205 and the camera 210.

In one or more implementations, the computer 215 can negotiate or dictate to one or more of the weight measuring device 205 and the camera 210 when and at what frequency to sense for and/or transmit data values to the computer 215 (e.g., for power consideration of the computer 215 and/or the sensors 205 and 210). In an aspect, the computer 215 can negotiate or dictate that time between temporally adjacent data values of the weight measuring device 205 and the camera 215 be set within a predetermined duration.

For example, a time between temporally adjacent data values sensed by the weight measuring device 205 can be set to be at least 3 seconds apart whereas a time between temporally adjacent data values sensed by the camera 210 can be set to be at least 2 seconds apart and at most 5 seconds apart. The negotiating or the dictating by the computer 215 can take into consideration one or more of power consideration of the computer 215 and/or one or more of sensors 205 and 210, location of the computer 215 and/or one or more of sensors 205 and 210, and time of day consideration. For example, when and at what frequency to sense for and/or transmit data values to the computer 215 can be reduced during a time that the user is generally asleep (e.g., based on a pattern that is determined by the computer 215 and/or one or more of sensors 205 and 210).

In an aspect, one or more of the sensors 205 and 210 can be set to transmit a data value if a currently sensed data value differs from a previously transmitted data value by more than a threshold. In some cases, a rate of change in the sensed data can also be considered. For example, the sensors 205 and 210 can be set to transmit a data value only if a rate of change between a currently sensed data value and a previously transmitted data value is greater than a threshold (e.g., change between adjacent data values divided by time between sensing the adjacent data values is greater than a threshold). In an aspect, the time between temporally adjacent data values of the sensors 205 and 210 can be set within a predetermined minimum and/or maximum duration. When and at what frequency to sense for and/or transmit data values can take into consideration one or more of power consideration of the computer 215 and/or one or more of sensors 205 and 210, location of the computer 215 and/or one or more of sensors 205 and 210, and time of day consideration.

For example, one or more of the sensors 205 and 210 can be adjusted (e.g., by the computer 215 or autonomously by the sensors 205 and 210 themselves), so as to decrease the frequency with which the sensors provide information to the actuator in certain circumstances. As an example, a threshold number for the egg count can be set to three eggs. Using this example, one or more of the sensors 205 and 210 can be adjusted to decrease frequency with which information is provided by the sensors right after the refrigerator is stocked with eggs, thus containing more than the threshold egg count of three eggs. Alternatively, one or more of the sensors 205 and 210 can be adjusted to decrease frequency with which information is provided by the sensors right after an order is placed (e.g., online order is placed with a grocery store) to buy eggs, since the action of stocking the refrigerator has already been performed. In this example, such adjustments to the frequency at which information is provided by the sensors are generally temporary.

Based on type of information received from one or more of the sensors, a policy that is associated with the received data values can be selected (310). A policy includes at least one condition and at least one action to be performed when a condition is satisfied. The computer 215 can select a policy based on receiving the data values associated with the number of eggs from one or more of the sensors (e.g., 205, 210). In this case, the selected policy includes a condition related to the egg count and an action to be performed when the condition is satisfied. In some aspects, policies can be stored in a database in one or more of the devices in the network 250. Alternatively or in conjunction, the policies can be stored remotely in one or more devices outside of the network 250, and the network 250 can access and/or download the policies from these remote devices via the network 280.

A determination can be made as to whether a data value among the received data values satisfies the condition at a time instance (315). The computer 215 can compare the egg count with the condition. For example, the condition can be that the egg count is less than three, and the action can be to communicate with a store (e.g., a store's website) to order more eggs when the condition is satisfied.

The action of the policy can be performed if the condition of the policy is satisfied at a time instance (320). If the computer 215 determines that the number of eggs is less than three, the computer 215 can communicate with the store through the network 220 (e.g., the Internet) and order eggs on behalf of a user for example.

A pattern can be determined from the received data values based on changes in the received data values as a function of time (325). In one or more implementations, the pattern can be determined based on heuristics. The computer 215 can store (e.g., in memory) a log with the egg count from the sensors along with a date and time associated with each egg count. Based on information stored in the log, if the computer 215 determines for example that the egg count has been decreasing at a faster rate recently, the computer 215 can determine a pattern that reflects such a change in behavior (e.g., of the user).

Based on the determined pattern, adjustments to the policy can be prepared (330). For example, if the computer 215 determines a pattern that the user utilizes many eggs every Saturday morning, the computer 215 can adjust the condition such that if the number of eggs is less than ten (as opposed to three) on Friday in particular (as opposed to other days of the week) the computer 215 will communicate with the store (e.g., via network 220) to order more eggs. In such a case, a single policy can have two conditions, a first condition relating to an egg count less than three on all days of the week aside from Friday and a second condition relating to an egg count less than ten on Friday in particular. Alternatively, two policies relating to the egg count can be in place, one policy relating to an egg count less than three on all days aside from Friday and one policy relating to an egg count less than ten on Friday in particular. In some aspects, two or more policies can be adjusted independently of one another. In other aspects, two or more policies can be sufficiently interrelated such that an adjustment to one policy leads to an adjustment to one or more of the other policies.

In one or more implementations, when preparing the adjustments to the policy, the condition, the action, or a combination of the condition and the action of the policy can be prepared for adjustment. As an example, if the computer 215 determines, based on the egg count from the sensors (e.g., 205, 210), that the egg count has been decreasing at a faster (slower) rate recently, the computer 215 can determine a pattern and prepare adjustments to the condition in the policy to increase (decrease) the threshold egg count of three that needs to be satisfied to trigger the action of ordering eggs. Alternatively or in combination, the computer 215 can determine a pattern and prepare adjustments to the action to order more (fewer) eggs at a time when making an order. In either of these cases, considerations such as cost (e.g., cost of eggs, cost of shipping/handling of the eggs), user preferences, and so forth can play a role in determining the adjustments to the policy that are prepared.

In one or more implementations, the computer 215 can identify a pattern based on the data values received from the sensors 205 and 210 over time and determine that the condition of the policy is repeatedly being met. Upon identifying such a pattern, the computer 215 can make a determination that the policy (e.g., the condition and/or the action) should be adjusted. For example, if a condition of the threshold egg count of three is met many times within a week, the action of ordering more eggs is accordingly performed many times within the week. The action might be cumbersome to the computer 215 (e.g., power and computation considerations) and the user (e.g., cost of shipping/handling for individual orders, possibility of lost shipments). In one example, the computer 215 can prepare adjustments to change the action such that more eggs are ordered in a single order in order to reduce the frequency at which the condition is met.

In the above example, the policy can be considered as repeatedly being met if the policy is met more than three times within a seven day interval for example. In one or more implementations, a first policy can be created such that its condition evaluates whether a condition relating to a second policy has been frequently met (e.g., met more than three times within a seven day interval), and the action of the first policy can be to adjust the second policy (e.g., adjust the action of the second policy to order more eggs with each order). The first and/or second policies can be created and/or adjusted by the computer 215 autonomously or with the user's approval or by the user.

As another example, the computer 215 can identify a pattern based on the data values received from the sensors 205 and 210 over time and can determine that the condition of the policy is rarely met or only met when the user has to throw out spoiled eggs. The refrigerator in this case is too well stocked compared to the relative slow consumption of the user of the eggs. The computer 215 can make a determination that the action should be adjusted to order fewer eggs each time the threshold egg count is met and/or to lower the threshold egg count (e.g., to zero such that eggs are only ordered when the user has completely run out of eggs).

In some implementations, the computer 215 can be designed with autonomy to proceed with adjusting the policy based on the prepared adjustments. In other implementations, the computer 215 can request feedback, such as from a user, for authorization to adjust the policy and/or the sensors based on the prepared adjustments. The computer 215 can also be designed with autonomy to proceed with adjusting the policy in some cases but not in other cases. For example, the actuator can have autonomy to adjust the policy when the policy adjustments are associated with a cost increase below a set threshold (e.g., set by the user) whereas the actuator can be set to request feedback for authorization when the policy adjustments are associated with a cost increase above the set threshold. Other manners by which to allow or deny autonomy, distribute intelligence, and/or distribute responsibility (e.g., tasks set/expected to be performed by a given device) are possible, and implementation details are dependent on particular application of the system of sensors and actuators.

Once the policy is adjusted, the policy can be stored in the computer 215 or at another device or database (e.g., a database that stores policies of the user). Subsequent data values relating to the egg count can be evaluated based on the adjusted policy. In one or more implementations, determined patterns and prepared adjustments will be made using the adjusted policy as a new baseline.

In one or more implementations, the same actuator or actuators (e.g., computer 215) can be utilized to perform the action, determine the pattern, and prepare the adjustment to the policy. In one or more implementations, one or more actuators can be utilized to perform the action whereas other actuator or actuators can be utilized to determine the pattern and prepare the adjustment. In one or more implementations, there can be an overlap between the actuators that are utilized to perform the action, determine the pattern, and prepare the adjustment.

In one or more implementations, the policy adjustments can include adjusting one or more of the sensors. For example, if the determined pattern identifies that the user has not been consuming as many eggs recently and, accordingly, the egg count has stayed constant for long periods of time, the policy adjustments can include adjusting one or more sensors to decrease the frequency at which to sense for and/or transmit data values.

With continued reference to policies related to an egg count, FIG. 2B illustrates an example network 250 of interoperable devices in accordance with one or more implementations. The network 250 includes a weight measuring device 255, a first camera 260, additional cameras 265 and 270, and a computer 275. The network 250 can be connected to another network 280, such as the Internet. As shown in FIG. 2B, the network 250 can be connected to the network 280 via the computer 275 for example. The weight measuring device 255 and the first camera 260 can provide an egg count, as previously described in relation to FIG. 2A. For example, one or more of the weight measuring device 255 and the first camera 260 can be providing an egg count to the computer 275.

In the network 250 shown in FIG. 2B, the additional cameras 265 and 270 can be, for example, cameras placed in different rooms of an apartment of the user. The additional cameras 265 and 270 can determine whether any additional people aside from the user are present and, if additional people are present, whether the additional people might be staying for a short time (e.g., for just a meal) or staying for a longer duration at the apartment. The additional cameras 265 and 270 can communicate with one another to verify the information that each camera gathers as well as make determinations regarding the situation. For example, one camera (e.g., 265) can gather information of people entering the main entrance of the apartment whereas another camera (e.g., 270) can gather information of people entering a bedroom in the apartment. If a person enters the main entrance (e.g., information recorded by camera 265) but never enters the bedroom, information from the cameras 265 and 270 can be utilized to make a determination that the person is likely not staying overnight at the apartment for example.

Based on the determination, the policy of ordering eggs when the egg count is less than three can be replaced or superseded by another policy. For example, if a determination is made that additional people are staying in the apartment, the computer 275 can adjust an existing policy or select a different policy to accommodate the determination. The policy to put in place can involve setting the condition to an egg count of less than ten (e.g., rather than three) and performing an action of ordering two dozen eggs (e.g., rather than one dozen) when the condition is satisfied. In one or more implementations, a policy can have multiple conditions and/or multiple actions, and in the example above the number of people in the apartment can be a factor in one or more conditions in the policy.

Although not shown in FIG. 2B, other interconnections (e.g., wired or wireless) between the devices 255, 260, 265, 270, and 275 are possible. Information can be provided between sensors, between actuators, and/or between a sensor and an actuator. In one or more implementations, data values gathered by one sensor (e.g., 255) can be transmitted to another sensor (e.g., 265) such that the devices can be more informed about the situation (e.g., whether additional people are staying in the apartment). Also, the interconnections can be utilized for troubleshooting purposes. For example, since both the weight measurement device 255 and the camera 260 estimate the egg count, the devices 255 and 260 can be time-synchronized in terms of gathering their data values and can compare their data values with each other. If a non-negligible difference is detected in the egg counts of the two devices 255 and 260, a notification (e.g., to the computer 275) can be provided to indicate that one or both of the devices 255 and 260 might need to be fixed. In one or more implementations, a determination can be made (e.g., by a user, by the computer 275, by the devices 255 and 260 themselves) as to which device is more likely to be in need of repair. The device determined to be in need for repair can stop operating, since data values obtained by the device are likely to be more inaccurate than the other device. In one or more implementations, one actuator can communicate information with one or more actuators, such as to compare or negotiate adjustments to policies.

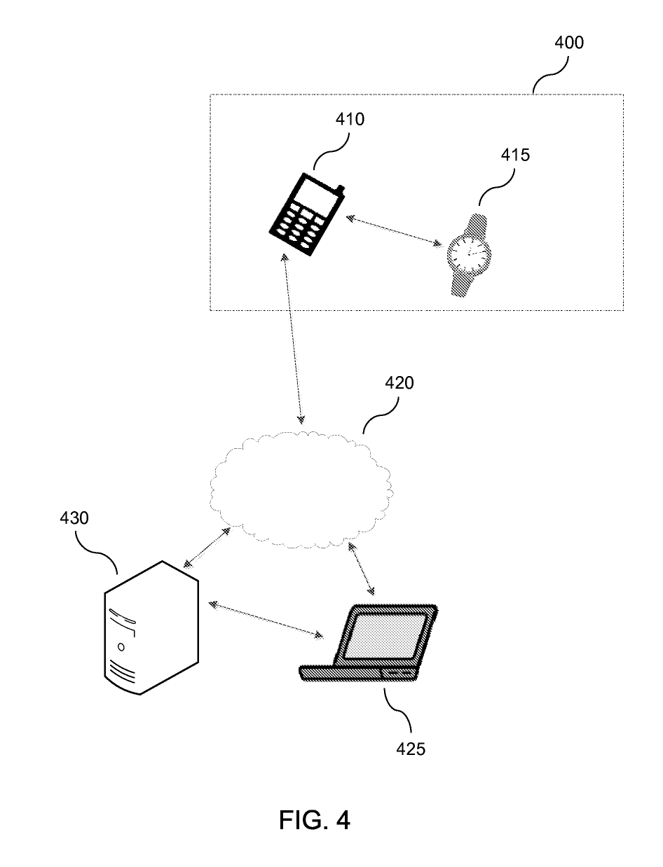

FIG. 4 illustrates an example network 400 of interoperable devices in accordance with one or more implementations. The network 400 includes a cell phone 410 and a watch 415. The network 400 can be connected to another network 420, such as the Internet. The network 420 can be connected to a first computer 425 and a second computer 430. The various interconnections between the devices are shown for purposes of discussion and by way of example. Different connections between the devices, more connections, or fewer connections are possible.

For discussion purposes, a user can wear a watch 415, where the watch 415 estimates the user's heart beat rate (e.g., by measuring the user's pulse rate). The watch 415 can transmit the heart beat rate to the cell phone 410. A policy can be selected by the cell phone 410 based on the received data values being heart beat rates. The policy can have a first condition associated with a particular range of heart beat rates and an action of sending the measured heart beat rates to a first computer 425 associated with (e.g., situated in) a hospital when the heart beat rates are outside the particular range of typical heart beat rates. For example, the cell phone 410 can send a message to a medical professional or an automated system that provides the heart beat rates of the user when the heart beat rates are outside the particular range of heart beat rates, and the message can be accessed at the first computer 425.

Consider that the user has previously been associated with a heart-rhythm disorder such that when the user's heart beat rate is outside the particular range of heart beat rates the user is at a higher chance of fainting. The policy can have a second condition such that, when the heart beat rate remains outside the particular range of heart beat rates for too long, the user receives a message from the first computer 425 at the cell phone 410 recommending that the user visit a hospital. The receiving of the call can be considered the action in response to the second condition. The policy can have a third condition such that, when the heart beat rate drops abruptly (e.g., indicating the user's life might be in danger), the cell phone 410 can send a message to both the first computer 425 and the second computer 430 and/or the cell phone 410 can receive a message from one or both of the first computer 425 and the second computer 430 asking the user to respond. The second computer 430 can be associated with an emergency response system that can dispatch help to the user if necessary, such as if the user does not respond to the message within a predetermined amount of time (e.g., a few minutes) or the user responds that help is necessary.

One or more of the cell phone 410, first computer 425, and second computer 430, for example, can keep track of the user's visits to a hospital and heart beat rates prior to a visit to the hospital. A pattern can be determined based on the visits to the hospital and associated heart beat rates. Based on the determined pattern, one or more of the cell phone 410, first computer 425, and second computer 430 can prepare adjustments to the policy (e.g., set a broader or narrower range for the heart beat rate as the condition for triggering an action).

The interoperable devices shown in FIGS. 2A, 2B, and 4 are examples only, and other example environments involving interoperable devices are possible. Additionally, policies and patterns need not be quantitative. For example, if a device senses a pattern that a user puts a cell phone on silent whenever the user is in a movie theater, a policy can be put in place with the condition that if the cell phone determines that the user is in a movie theater, then the cell phone sets itself to silent. The device that senses the pattern can be the cell phone itself and/or another device (e.g., a watch worn by the user).

Since a network (e.g., 200 in FIG. 2A, 400 in FIG. 4, etc.), such as an IoT network, can involve a large number of sensors and other data generating devices, a significant amount of generated data might be noise, and only a small amount might be useful for making the policy-based decisions. In one or more implementations, the actuator (e.g., computer 215 in FIG. 2A, cell phone 410 in FIG. 4, etc.) can negotiate or dictate to one or more of the sensors (e.g., camera 210 in FIG. 2A, watch 415 in FIG. 4, etc.) when and at what frequency to transmit data values to the actuator (e.g., for power considerations of the actuator and/or the sensors). In an example, the sensors can be set to transmit a data value if a currently sensed data value differs from a previously transmitted data value by more than a threshold. In some cases, a rate of change in the sensed data can also be considered. For example, the sensors can be set to transmit a data value only if a rate of change between a currently sensed data value and a previously transmitted data value is greater than a threshold (e.g., change between adjacent data values divided by time between sensing the adjacent data values is greater than a threshold).

In an aspect, the actuator can negotiate or dictate that time between temporally adjacent data values of the sensors be set within a predetermined duration. For example, a time between temporally adjacent data values sensed by one of the sensors can be set to be at least 2 milliseconds apart whereas a time between temporally adjacent data values sensed by another sensor can be set to be at most 1 minute apart. The negotiating or the dictating by the actuator can take into consideration one or more of power consideration of the actuator and/or one or more of the sensors, location of the actuator and/or one or more of the sensors, and time of day consideration.

Additionally, the sensors can have different characteristics, such as precision and speed of sensing data values. For example, a first sensor can be utilized for cheap, rough estimates of a user's blood pressure whereas a second sensor can be utilized for relatively expensive, but precise, estimates of the user's blood pressure. In some applications, the first sensor can be set to sense for and/or transmit the estimated blood pressure more frequently, to a system that stores or analyzes blood pressure information, than the second sensor. In another application, the second sensor can be instructed by the system to turn on and sense for and transmit estimated blood pressure values only when the first sensor provides a blood pressure outside of what is considered a typical range (e.g., outside of a range considered to be healthy).

In one or more implementations, a sensor can have autonomy (e.g., in some cases or in all cases dependent on application) to decide when and at what frequency to sense for and/or transmit data values. Similarly, in one or more implementations, an actuator can have autonomy to decide which sensor or sensors to receive (or not receive) information from and/or autonomy to make adjustments to policies. The intelligence and/or processing can be distributed throughout the network, such as to an actuator and to a sensor within the network, e.g. to minimize communications with a central data server and/or cloud and/or to reduce latency in decision making processes.

More generally, in an IoT network, it can be desirable to distribute intelligence and/or processing throughout the network (e.g., devices throughout the network), e.g. to minimize communications with a central data server and/or cloud and/or to reduce latency in decision making processes. An IoT network with distributed intelligence can include an intelligent edge, such that preprocessing and/or real-time control loops are performed in proximity of the edge devices. The IoT network with distributed intelligence can further include processing resources distributed at different nodes of the network, e.g. between the edge and a central server and/or cloud. For example, gateway devices, e.g. home gateways, can act as proxies between the edge and/or sensing devices and the data center and/or cloud resources.

If intelligence and/or processing resources are distributed throughout an IoT network, there can be multiple different processing resources that can be used to perform any given processing action. Thus, a mechanism that determines which resources perform which actions can be desirable. A resource capability adjudicator can determine where in the network, e.g. the appropriate processing resources and/or intelligence in the network, to perform various processing tasks and/or to perform various decision making tasks. The resource capability adjudicator can establish a decision loop for performing a decision making task and can map the decision loop to configure the network dynamically. The resource capability adjudicator can also provision network resources and/or compute resources for devices and/or services and can re-allocate provisioned resources when they are no longer in use.

Devices, including sensors, active devices, and actuators, in an IoT network can have access to information from external systems that might be relevant to the configuration of the devices. Thus, it can be desirable for a device in an IoT network to configure itself, e.g. to configure itself to perform an action, based on information sensed by, or received by, the device. Devices in an IoT network can correlate relevant data from multiple disparate data sources to self-configure and/or perform actions intelligently, e.g. based on the correlated relevant data and/or policies. For example, a mobile device can set itself to a silent mode when a user enters a movie theater.

Devices in an IoT network can have access to information from external systems that might be relevant to the configuration of the devices. Thus, it can be desirable for a device in an IoT network to configure itself, e.g. configure itself to perform an action, based on information sensed or received by the device, e.g. in accordance with a policy. However, in one or more implementations, the device and/or the user of the device might not have the knowledge and/or capability to create and/or configure such a policy. A device in an IoT network can self-configure based on a policy and/or configuration settings of a similar device (e.g. a device running the same operating system) that were implemented by an “expert user”. The expert user and the expert user's device can be identified and/or verified by a third party, e.g. a registrar, or can be organically identified through the network, e.g. a user who spends a significant amount of time configuring the device, a user whose device configurations and/or policies are copied, e.g. “followed”, by a large number of other users, etc.

Devices in an IoT network can generate a large amount of data, some of which might be redundant or of low value. Thus, a mechanism that enables filtering of low value or redundant data can be desirable. A pre-conditioning and/or pre-classifying agent can pre-classify and/or pre-condition and/or filter and/or aggregate data being generated in an IoT network such that high quality and/or value data can be distilled from low-quality and/or high-value data in the IoT network. In addition, the agent can identify data that should be pre-emptively cached based on the location of consumers of the data and the agent can cause the data to be pre-fetched and cached at a network node.

Devices in an IoT network can provide different sensor data at different times and/or in different formats. Thus, there might be a need for a malleable application that can adapt to the data that is being provided by devices at any given time. A reconditioning agent can recondition, or reconfigure, an application based on the data that is being provided to the agent by one or more sensors in an IoT network. For example, an application can be configured to provide information X based on received sensor data, but the available sensor data might not include information X, or information from which information X is derivable. In this instance, the reconditioning agent can reconfigure the application to provide information Y (which may be the closest available information to information X) based on data received from the sensors.

It can be desirable for sensor data that is generated in an IoT network have a time association, e.g. so that the data can be presented to actuator devices and/or processing devices at specific time intervals. However, some “dumb” sensor devices might not include timing and/or synchronization mechanisms. A system for time synchronizing sensor devices can append a timestamp to any data that is generated by sensors. For example, sensors that include timing mechanisms can self-synchronize with the IoT network and append timestamps to generated data, while a proxy device, such as a gateway device, can synchronize with the IoT network and append timestamps to data generated by “dumb” sensors and/or devices.

Devices in an IoT network can generate a significant amount of data that might be undecipherable or unusable by an average user and/or an average device. An expert agent, e.g. commercial entities, can provide decision making services for a user based on information generated by devices that are associated with the user, e.g. medical decisions. An expert agent can also perform a commercial pre-classifying and preconditioning of data generated by devices that are associated with a user. The decision making services can be automated or manual dependent on the application (e.g., type of decisions that are made). As previously indicated, an active device or actuator (e.g., computer 215 in FIG. 2A) that performs an action of a policy can be provided with autonomy in some cases. In other cases, the active device or actuator can inform the user prior to performing the action or can ask the user for permission to perform the action.

The behavior of a user can affect the configuration and/or operation of devices associated with the user. A personal agent (e.g., a computer 215 in FIG. 2A) can continually observe and/or learn a user's behavior over time and can use the learned behavior of the user for future decision making processes, e.g. to control and/or configure devices that are associated with the user. The personal agent can adapt policies that are associated with the devices of the user based on the learned behavior of the user. The adaptation of or adjustment of the policies can be automated or manual. The policies can be generated or created through heuristics.

In one or more implementations, the personal agent can be designed with autonomy to proceed with adjusting the policies based on the prepared adjustments. In other implementations, the personal agent can request feedback, such as from the user, for authorization to adjust the policies. The personal agent can also be designed with autonomy to proceed with adjusting the policies in some cases but not in other cases. For example, the personal agent can have autonomy to adjust the policies when the policy adjustments are associated with a cost increase below a set threshold (e.g., set by the user) whereas the personal agent must request feedback for authorization when the policy adjustments are associated with a cost increase above the set threshold. Other manners by which to allow or deny autonomy, distribute intelligence, and/or distribute responsibility (e.g., tasks set/expected to be performed by a given device) are possible, and actual manners that are implemented are dependent on particular application associated with the personal agent (e.g., types of decisions made by the personal agent).

As common devices become interconnected in IoT networks, it may be desirable to simplify the commercial model and/or technology development for the devices. A technology platform can be provided for simplifying technology development of devices in an IoT network and increasing the velocity of innovation of such devices.

Since an IoT network may include multiple disparate sensors that provide multiple streams of data, it might be difficult to simulate an IoT network and the generated data streams, e.g. for application development and/or testing purposes. An IoT application development platform can include middleware that allows users to access live datasets from sensors without disturbing live agents and/or programs that are accessing the data. Access to the live datasets can greatly reduce the application development complexity and can allow for thorough testing of applications and/or devices before they are released to market. In some instances, the middleware might include anonymizing agents that remove any user identifiable data from the live datasets. The end users can also be given control of whether data from their devices can be used for application development purposes. The application development platform can also include a simulation environment that can be used to score applications and can be used to simulate software running on different types of devices in the IoT network.

As common devices such as appliances (e.g., refrigerators, watches, etc.) become interconnected in an IoT network, a mechanism for the devices to self-initialize and/or register might be desirable. For example, some devices in an IoT network might not include a display and/or other configuration interface. A self-initializing and/or credentialing device in an IoT network can associate itself with a user, e.g. allow a user to establish ownership, based on one or more triggers. For example, the device can become associated with the user based on a credit card transaction when the device is purchased. Alternatively, or in addition, the device can become associated with the user by placing the device in a particular “pairing” location in the user's dwelling place, e.g. using Wi-Fi indoor location tracking, etc. The self-initialization of the device might not require any configuration of the device by the user.

Once the device is associated with the user, the device can advertise its services and/or capabilities and/or network requirements to the IoT network, e.g. to other devices and/or applications in the IoT network that are associated with the user. The device can self-configure an initial configuration based on the configurations of surrounding devices. For example, the device can self-configure to utilize transmission protocols and/or standards that are being used by other devices associated with the user or in the user's home network. In addition, the device can request a translator and download protocols, as necessary, and the device can determine any drivers and/or protocols that might need to be downloaded to other IoT devices, e.g. for purposes of communicating with, and/or accessing services of, the device.

Some devices (e.g., sensors) in an IoT network might have temporary utility. As such, it can be desirable for such devices to be reconfigurable for other purposes. A reconfigurable sensor or general purpose sensor can be reconfigured to perform a different behavior, provide a different output, etc. The reconfigurable sensor can be physically, or logically, rented, i.e. a rent-a-sensor. For example, a sensor itself can be physically rented, or the data feed provided by the sensor can be rented, i.e. logically renting the sensor. Furthermore, a general purpose sensor can be configured to provide different types of information to different user classes.

In view of the large number of sensors and/or devices that are expected to exist in IoT networks, it might be desirable to have a mechanism for revoking the authentication of a sensor, e.g. when the sensor is tampered with, or invalidating a sensor, e.g. when the sensor is providing inaccurate data or otherwise is malfunctioning. A revocable sensor authentication and/or validation system can be configurable to revoke a sensor's authentication and/or validation based on one or more policies, e.g. when the sensor is moved, when the sensor is determined to be providing inaccurate data, or through heuristics.

In view of the large number of sensors and/or devices that are expected to exist in IoT networks, it might be desirable to have a mechanism for determining when a sensor is providing inaccurate data or is otherwise malfunctioning. A node of an IoT network (or a built-in self-test (BIST) of a sensor) can determine that the sensor is providing inaccurate data when the data provided by the sensor varies significantly from data provided by other sensors that are expected to be providing similar data, e.g. temperature sensors that are located in the same geographic area. In order to minimize the amount of inaccurate data being transmitted through the IoT network, the sensor can be deactivated, or otherwise taken offline. The sensor can be remotely recalibrated, e.g. based on data received from the similarly situated sensors and can be remotely tested (e.g., using BIST) after recalibration. If the sensor passes the testing, the sensor can be remotely reactivated.

Since IoT sensors and/or devices can often be associated with a particular person, there might be a need for a system for transferring ownership of an IoT sensor and/or device from one person to another, e.g. when the sensor and/or device is sold or otherwise transferred from one person to another. In a system for transferring ownership of an IoT sensor and/or device, a registrar or trusted authority can provide digital “birth certificates” for IoT sensors and/or devices, e.g. including a private key.

In view of the large number of sensors and/or devices that are expected to exist in IoT networks, there can be significant complexity associated with managing such devices. Thus, a system for managing devices and/or sensors in an IoT network might be desirable. A system for managing sensors in an IoT network can manage a group of sensors, e.g. sensors associated with a user, sensors associated with an intranet, etc. The management system can provide location information, e.g. for industrial sensors and/or can utilize an application programming interface (API) that is location-based.

Since IoT devices can include a diverse set of disparate devices, it might be desirable to have a universal vocabulary for communicating with and/or between the devices. A system that has a universal vocabulary, or basic machine-to-machine language capabilities, can allow disparate devices to communicate with one another, as well as allowing users to communicate with the devices. For example, the vocabulary can facilitate communication of an instruction and/or action by a human to a device, e.g. in plain English phrases or through some other form of abstraction. The vocabulary can be scalable such that new additions can be added to the vocabulary, e.g. for more complex actions. The system can further include translators for communicating with legacy devices. In one example, the vocabulary can be, or can include, an STN model for IoT devices.

Since different IoT networks might not be federated or otherwise capable of communicating with one another, a mechanism for enabling a device to communicate across different IoT networks might be desirable. A portable smart agent can reside in one or more IoT networks and can authenticate and/or federate across disparate IoT networks; i.e., the smart agent can exist across disparate IoT networks in a federated way. Thus, the smart agent is able to communicate with devices and/or networks with a common trust.

Since the number of sensors in IoT networks are expected to increase significantly, the number of device addresses that can be provided under current network address systems and/or techniques might quickly be exceeded. In addition, the structure of current network address systems might not be well-suited for devices in an IoT network, e.g. devices that can have spatial associations. In a location and/or capability based address system, devices can have addresses that are indicative of their location and/or capabilities, e.g. geospatial addresses, content-addressable addresses, addresses that are a quantization of the longitude and/or latitude of the devices, etc. In this manner, devices can be addressed based on their geographic and/or spatial location, e.g. to retrieve data from all sensors located within 10 feet of a user. Similarly, devices can be addressed based on their capabilities, classes, domains, etc., e.g. retrieve all temperature sensor data within a mile of a user. Alternatively, or in addition, data generated by the devices can be geo-tagged using the geospatial addresses, e.g. by the devices and/or by network nodes, to identify the locations where the data was generated and/or to identify the locations of the network nodes that the data passed through.

In view of the large number of data generating sensors and/or devices that are expected to exist in IoT networks, for any given application a significant amount of the generated data can be noise, and only a small amount of the data can be useful. In a system for reducing verbosity of information in an IoT network, sensors and/or intermediary devices can be configured to only transmit sensor data at certain intervals, e.g. when the data is changing. The system can further utilize the rate that the data is changing to determine how often updates are sent.

In some instances, users might wish to simultaneously view and/or interact with data across multiple disparate IoT networks. For example, a doctor might wish to view and/or interact with an MRI from his home, while a radiologist views and/or interacts with MRI in a hospital, etc. A point-to-multipoint communication system in an IoT network can determine, at each network node, how to transmit information to the IoT networks connected to the node, e.g. broadcast, multicast, etc. The system can separate the information being transmitted into layers and can only transmit the layers that have changed when updates occur. The system can also establish a global clock for the application that is communicating the information, since the information is communicated over multiple disparate networks that can each have their own clocks and/or timing mechanisms.

In view of the large number of sensors and/or devices that are expected to exist in IoT home networks, and the associated complexity of managing and/or communicating with such devices, it can be desirable to include an intermediary device, such as a home gateway, to act as a proxy for the IoT home network. A gateway device for a home IoT network can receive data from sensors in the network and transmit the data to applications, agents, devices, etc. In order to conserve network resources, the gateway device can cache data received from multiple devices and can transmit the data in aggregate, might transmit the data only when it is requested, or might transmit the data during off-peak hours. The gateway device can also implement privacy control for the sensors and/or devices in the home gateway, such as datagram based privacy. The gateway device can also anonymize sensor data, e.g. for transmission to applications and/or devices that are not authorized to receive identifiable data associated with the user. The gateway device can emulate the IoT devices in the home network such that the devices appear to always be connected, even though the devices can be sleeping or in a low-power mode, e.g. the gateway can query the devices when necessary. The gateway device can also control and/or filter the data that is provided to the outside network, e.g. to reduce redundant data. The gateway device (or other intermediary device) can implement an abstraction layer of what data can be associated with a user and what cannot.

Since properties and/or addressing of IoT sensors can be location based, it can be desirable for an IoT network to determine when an IoT sensor has been moved or otherwise tampered with. If a node of an IoT network determines that a sensor has been moved, the level of security associated with the sensor can be changed, e.g. based on the amount and/or distance that the sensor has been moved. For example, the authentication of the sensor can be revoked if the sensor is moved a short distance, while the sensor can be remotely deactivated if the sensor moves a longer distance. The sensor can include a mechanism that detects when the sensor is moved and/or one or more nodes in the IoT network can determine that the sensor has moved based on positioning mechanisms. As the number of IoT devices increases, there can be one or more commercial markets for the information generated by the IoT devices. A revenue generation system for an IoT network can implement a subscriber based system for receiving data feeds from IoT devices. For example, an online marketplace can enable end users (or some higher level entity) to sell information from IoT sensors and/or devices to third parties, e.g. using a subscriber model, an auction model, etc.

In a machine-to-machine communication network, the security and/or privacy of any application and/or communication can be dependent on the location of all of the devices and/or sensors involved in the application and/or communication, e.g. not only the end-user device. A device in an IoT network can be configured to allow the privacy and security policy for an application to be set based on the collective locations of all of the devices and/or sensors in the IoT network that are utilized by the application, e.g. sensors from which data is retrieved, network devices that are in the communication path, etc. Furthermore, the device can allow a user to limit the privacy changes to the device based upon the location of the device in the IoT network. The privacy and/or security can be set by the user associated with a device, e.g. the owner, and the privacy and/or security can be unique for a data type, e.g. not for a physical channel or a logical channel.

A low-power wireless sensor with a camera might be desirable in an IoT network. An IoT sensor device can have a camera and a wireless data connection. An IoT sensor device can communicate via modulated light, e.g. solar and/or optical sensor. An IoT sensor device can be powered by magnetics, a battery or light. The light communication sources can be from a modulated backlight of a phone, or via a ceiling light bulb associated with the IoT device. For example, the IoT sensor device can be inside an LED light bulb, or elsewhere. The IoT sensor device can include low power motion sensing technology and might be able to post process and identify objects in the optical field of view. The IoT sensor device can utilize smart processing to extract complex conclusions from the sensor data. The IoT sensor device can pass image data to applications along with other images to extract complex tasks and 3D views, e.g. determining who walked in a room, where they sat down, when they sat down, etc. The IoT network could pass along needs, such as count the number of times someone opened a window. An optical IoT sensor device can include non-visible light spectrum. The IoT sensor devices can be identifiable by electronic signatures, optical signatures (visible or non-visible light spectrum), etc. The IoT sensor device can filter results based on information sensed by proximal sensors. For example, if there are ten people sitting in a room, the temperature determined by the sensor that is closest to the ten people can be self-weighted higher than the temperature determined by the other sensors. The sensor can also be wirelessly powered, e.g. powers up similar to NFC when wireless power transmission (WPT) is present. Similarly, for wearable, or internal sensors, power can be transferred through the body to the sensor to read, e.g. similar to how NFC uses e-fields to read.

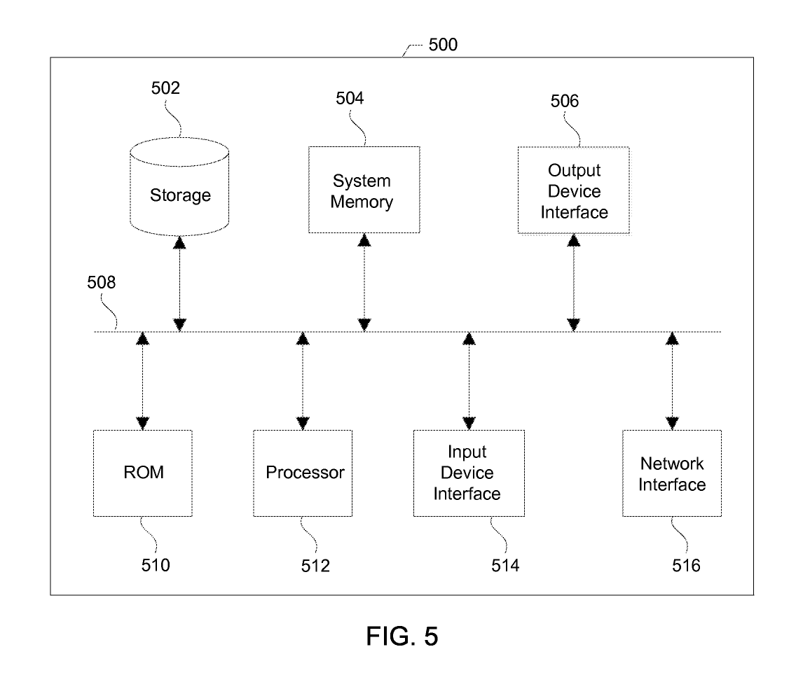

FIG. 5 conceptually illustrates an example electronic system 500 with which some implementations of the subject technology can be implemented. Electronic system 500 can be a gateway device, a set-top box, a computer (e.g., desktop computer or laptop computer), a phone, a personal digital assistant (PDA), a server, a switch, a router, a base station, a receiver, or any other sort of electronic device that transmits signals over a network, such as electronic devices embedded in smart appliances and other smart systems. The electronic system 500 can be, and/or can be a part of, the proxy device (e.g., within 102A in FIG. 1) and/or one or more of the devices (e.g., 104A-104D in FIG. 1). For example, the electronic system 500 can be a sensor, an active device, and/or an actuator. Such an electronic system includes various types of computer readable media and interfaces for various other types of computer readable media. Electronic system 500 can include, but is not limited to, a bus 508, processing unit(s) 512, a system memory 504, a read-only memory (ROM) 510, a permanent storage device 502, an input device interface 514, an output device interface 506, and a network interface 516, or subsets and variations thereof.

The bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502. From these various memory units, processing unit(s) 512 retrieves instructions to execute and data to process in order to execute the processes of the subject disclosure. The processing unit(s) 512 can be a single processor or a multi-core processor in different implementations.

The ROM 510 stores static data and instructions that are needed by processing unit(s) 512 and other modules of the electronic system 500. Permanent storage device 502, on the other hand, is a read-and-write memory device. This device is a non-volatile memory unit that stores instructions and data even when electronic system 500 is off. Some implementations of the subject disclosure use a mass-storage device (for example, a magnetic or optical disk and its corresponding disk drive) as permanent storage device 502.

Other implementations use a removable storage device (for example, a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such as a random access memory. System memory 504 stores some of the instructions and data that the processor needs at runtime. In some implementations, the processes of the subject disclosure are stored in system memory 504, permanent storage device 502, or ROM 510. For example, the various memory units include instructions for making policy-based decisions in a network in accordance with some implementations. From these various memory units, processing unit(s) 512 retrieves instructions to execute and data to process in order to execute the processes of some implementations.

The bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, for example, cathode ray tubes (CRT) or liquid crystal displays (LCD). Some implementations include devices, for example, a touchscreen that functions as both input and output devices.

Finally, as shown in FIG. 5, bus 508 also couples electronic system 500 to a network (not shown) through a network interface 516. In this manner, the computer can be a part of a network of computers (for example, a local area network (LAN), a wide area network (WAN), or an Intranet, or a network of networks, for example, the Internet. Any or all components of electronic system 500 can be used in conjunction with the subject disclosure. The network interface 516 can include cellular interfaces, WiFi interfaces, Infrared interfaces, RFID interfaces, ZigBee interfaces, Bluetooth interfaces, Ethernet interfaces, coaxial interfaces, optical interfaces, or generally any communication interface that can be used for device communication. The communications can be performed with a network environment such as the network environment 100 of FIG. 1.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method, comprising:
receiving data values from at least one sensor at a plurality of time instances;
selecting a policy associated with the received data values, wherein the policy comprises a condition and an action;
determining whether a data value among the received data values satisfies the condition at one or more time instances among the plurality of time instances;
performing the action of the policy if the condition of the policy is satisfied at one or more time instances among the plurality of time instances;
determining a pattern from the received data values based on changes in the received data values as a function of time; and
preparing adjustments to the policy based on the determined pattern.

2. The method of claim 1, further comprising adjusting the policy based on the prepared adjustments.

3. The method of claim 2, further comprising:
receiving an additional data value from the at least one sensor;
selecting the adjusted policy;
determining whether the received additional data value satisfies a condition of the adjusted policy;
perform an action of the adjusted policy if the condition of the adjusted policy is satisfied;
determining a pattern based on changes between the received additional data value and previously received data values; and
preparing adjustments to the adjusted policy based on the determined pattern.

4. The method of claim 2, further comprising adjusting a sensor among the at least one sensor based on the prepared adjustments.

5. The method of claim 1, further comprising:
receiving feedback on whether to authorize the prepared adjustments; and
adjusting the policy based on the prepared adjustments if authorization is received.

6. The method of claim 1, wherein difference between data values corresponding to adjacent time instances is larger than a threshold.

7. The method of claim 1, wherein the pattern is further based on rate of change in the received data values as a function of time.

8. The method of claim 1, further comprising determining the plurality of time instances at which data values are received from the at least one sensor.

9. The method of claim 8, wherein the determining of the plurality of time instances is based on one or more of power consideration of the at least one sensor, location of the at least one sensor, and time of day consideration.

10. The method of claim 1, wherein the receiving, the selecting, the determining, the performing, the determining of the pattern, and the preparing are performed by one or more actuators.

11. A system, comprising:
one or more processors; and
a non-transitory computer-readable medium comprising instructions stored therein, which when executed by the one or more processors, cause the one or more processors to perform operations comprising:
receiving a data value from at least one sensor;
selecting a policy associated with the received data value, wherein the policy comprises a condition and an action;
determining whether the received data value satisfies the condition;
performing the action of the policy if the condition of the policy is satisfied;
determining a pattern based on changes between the received data value and previously received data values; and
preparing adjustments to the policy based on the determined pattern.

12. The system of claim 11, wherein the instructions, when executed by the one or more processors, cause the one or more processors to perform operations further comprising adjusting the policy based on the prepared adjustments.

13. The system of claim 12, wherein the instructions, when executed by the one or more processors, cause the one or more processors to perform operations adjusting a sensor among the at least one sensor based on the prepared adjustments.

14. The system of claim 11, wherein the instructions, when executed by the one or more processors, cause the one or more processors to perform operations further comprising:
receiving feedback on whether to authorize the prepared adjustments; and
adjusting the policy based on the prepared adjustments if authorization is received.

15. The system of claim 11, wherein the pattern is further based on rate of change in received data values as a function of time.

16. The system of claim 11, wherein the instructions, when executed by the one or more processors, cause the one or more processors to perform operations further comprising determining time instances at which data values are received from the at least one sensor.

17. A device of a network, the device comprising:
memory;
one or more processors coupled to the memory and configured to execute one or more instructions from the memory to perform:
receiving a data value from at least one sensor;
selecting a policy associated with the received data value, wherein the policy comprises a condition and an action;
determining whether the received data value satisfies the condition;
performing the action of the policy if the condition of the policy is satisfied;
receiving adjustments to the policy, wherein the adjustments are based on changes in the received data value and previously received data values; and
adjusting the policy based on received adjustments.

18. The device of claim 17, wherein the one or more processors are further configured to adjust the at least one sensor based on the received adjustments.

19. The device of claim 17, wherein the one or more processors are further configured to determine time instances at which data values are received from the at least one sensor.

20. The device of claim 17, wherein the adjustments are received from another device in the network.
